(19) United States
(12) Patent Application Publication
(10) Pub. No.: US 2004/0203581 A1
(43) Pub. Date: Oct. 14, 2004

(54) Method system and device for monitoring data pushed to a wireless communication device

(75) Inventors: Offer Sharon, Asseret (IL); Ran M. Bittmann, Tel Aviv (IL); Meir Lasry, Tel Mond (IL)

Correspondence Address: BROWDY AND NEIMARK, P.L.L.C., 624 Ninth Street, N.W., Washington, DC, 20001, US

(73) Assignee: mSAFE Ltd., Rehovot (IL)

(21) Appl. No.: 10/265,163

(22) Filed: Oct. 7, 2002

(51) Int. Cl. H04Q 7/20; H04M 11/00; H04M 3/42

(52) U.S. Cl. 455/406; 455/405; 455/403; 455/414.1

(57) ABSTRACT

A method, system and device are disclosed for monitoring and controlling data pushed to a client wireless communication device (WCD). A unit or device installed in or connected to the WCD utilizes filtering rules relating to pushed data for evaluating whether to drop the pushed data.

### FIELD OF THE INVENTION

This invention relates to means for monitoring activity of a wireless communication device such as a communication device communicating through a cellular system. A particular application of the invention is monitoring activities, such as transactions, performed utilizing the communication device for the purpose of charging, or crediting a client account. An example of a monitored activity is access, through the communication infrastructure to a computer network, e.g. the Internet, in particular for the purchase of products, services, content or data from sites of the network. The monitored activity is subsequently used to charge a client account accordingly.

### BACKGROUND OF THE INVENTION

Wireless communication is likely the most rapidly developing communication infrastructure. Wireless communication systems includes in particular cellular telephone and pager systems. Together with the rapid increase in use of cellular telephone systems throughout the world, the scope of use of cellular telephones is changing from a medium dedicated purely to voice communication, to a medium used also for a wide variety of other applications. In particular, moderm cellular telephones are installed with Internet access ability, making use of protocols such as the Wireless Application Protocol (WAP) developed therefor, while cellular telephone operators are beginning to provide a gateway through the cellular telephone networks to the Internet.

The Internet, in addition to being a medium for storing and retrieving information, is becoming a medium of choice for a wide variety of e-commerce transactions including purchasing of products or services, purchasing information, participating in gaming activity and others. The use of a cellular telephone for this purpose is advantageous in that each cellular telephone has a distinct I.D. and number, recognizable by the cellular telephone operator (also referred to as Service Provider), and thus the client performing a transaction can be easily identified for account-billing purposes (or also for the purpose of crediting a client account, in the case, for example, of winning in a gaming activity).

Reference is made to FIG. 1, which is a schematic representation of one manner of carrying out a transaction through the Internet using a wireless communication device in accordance with the prior art. The wireless communication device 120, for example a cellular telephone, communicates with the Internet, represented as cloud 122, through a wireless communication 124. Data is transmitted from device 120 to the Internet 122 and back from Internet 122 to device 120 through the cellular telephone infrastructure 124. Switches 126, being Internet server utilities, intercept relevant transaction data together with the I.D. of device 120. Detail records (DRs) 130 are then transmitted to a charging gateway 132 located at the cellular-system operator, which then charges or credits the client's accounts, as the case may be. This continuous monitoring and data collection by switches 126, is a major cause for degradation in performance, as it limits the rate of operation and billing.

Another manner of performing a transaction using a wireless communication device in accordance with the prior art can be seen in FIG. 2. In FIG. 2, like reference numerals to those of FIG. 1 are used, shifted by 100, to denote components having the same function (and the reader is referred to the description of FIG. 1 for explanation). Also in this prior art embodiment, in order for the operator to bill for the transactions, accounting information in the form of DRs 230 needs to be collected. In this case, in order to reduce the load from switches 226, data probes 236 are installed to probe all data intercepted by switches 226 and send this data as DRs 230 to a charging gateway 232 located at the cellular telephone operator. This solution requires installing many probes 236 that need to be as fast as Internet switches 226 and to be regularly updated with the newest protocol standards whenever such are released. The charging gateway 232 correlates this data to device 222, which is a relatively cumbersome procedure as data from even a single transaction may proceed through several paths. This provides a limit to the operator's billing options and to the growth of its network.

PCT Application, Publication No. WO 98/47116, discloses a teledata communication network which facilitates payments between a customer account to a merchant account. A service node is provided which acquires a merchant identifier and the transaction amount from the customer mobile communication device and then sends the transaction verification request message to both the customer mobile station and the merchant terminal. Upon receipt of the transaction verification, the service node requests the transfer of the transaction amount from the customer account to the merchant account.

European Patent Application No. 940783, discloses a mobile electronic payment terminal to which a standard mobile communication device, for example, a cellular telephone, may be connected to enable full mobile electronic funds transfer at point of sale transactions to occur. The payment terminal kept at the point of sale location can receive and accommodate the cellular telephone in order to perform a transaction.

PCT Application, Publication No. WO 01/82645 A1 discloses an arrangement and method for subscription to a cell broadcast service in a cellular radio communication system including a fixed network with base stations, arranged to communicate with mobile stations within cells. Said base stations are also arranged to transmit data on a broadcast carrier within a cell, for all mobile stations in said cell to receive. An encoding device is adapted to encoding in the fixed network of subscriber specific data by a symmetric key to a code (CW), and a data transmission device is adapted to transmission of the encoded subscriber specific data from the fixed network on a data channel on a cell broadcast carrier. Decoding device, adapted to decoding of said encoded subscriber specific data by said symmetric key to a code in a mobile station belonging to a subscriber to a broadcast service.

The continuous rapid increase in the number of users of cellular telephone systems, the growing complexity of the system and the increased diversity in the type of services provided to users, growing diversity in the type of quality of service provided to different users, such as location based services and increasing complexity and diversity of billing schemes (for example, content-based billing, third party billing, etc.) presents challenges which are extremely difficult to overcome in current cellular telephone systems. In addition to huge technical difficulties in designing and installing billing systems to suit modern use of cellular telephone systems, the manner of design of the current systems makes scalability a very difficult problem. One possible solution is to channel all communication traffic through a single activity-monitoring network node. This however creates a very serious bottle neck in the system. Furthermore, a system that monitors activity of a large number of users in a single node is extremely expensive to install.

### SUMMARY OF THE INVENTION

The invention provides a novel method, system and device for conveniently monitoring the activity of a wireless communication device (WCD). In accordance with the invention, the WCD contains a unit, which may be a hardware device, a software utility or a combination of the two and which probes, records and stores data relating to activity performed by a clients WCD. Such activity includes, for example: use of the wireless communication network in general, e.g. communication time or utilized bandwidth; utilization of special services, e.g. access to a computer network such as the Internet, to which a gateway is provided by the wireless communication service provider (to be referred to herein as the “service provider”); access of specific sites of the computer network that require payment for such access; purchase of products, services, content or data from sites of the computer network; payment made to the client, for example, in case of a win in a network gaming activity; etc. This activity data may be pulled by an activity-monitoring server utility or the activity data may be periodically pushed to the server utility by said unit. The transmission may be according to a configurable set of rules defined by the service provider or by a content provider, e.g. an Internet service provider.

According to the present invention there is provided a method for monitoring activity of a wireless communication device (WCD) of a client comprising: installing in or connecting a WCD to an activity-monitoring unit configured to intercept a message pushed over a wireless communication infrastructure of a wireless communication system to at least the WCD; upon interception of a pushed message, the activity-monitoring unit utilizing at least one filtering rule concerning pushed messages for evaluating how to treat the message; and if a result of the evaluating is to drop said message, the activity monitoring unit dropping the message.

According to the present invention, there is also provided, a device for installing in or connecting to a client wireless communication device (WCD), the device comprising a unit that is configured to intercept a message pushed to at least the WCD, to utilize at least one filtering rule concerning pushed messages to evaluate how to treat the intercepted message, and to drop the message if a result of the evaluating is to drop the message.

According to the present invention there is further provided a client wireless communication device (WCD), permitting a client to communicate over a wireless communication infrastructure, the WCD having or being connected to an activity monitoring unit which is configured to intercept a message pushed to at least the WCD, to utilize at least one filtering rule concerning pushed messages to evaluate how to treat the intercepted message, and to drop the message if a result of the evaluating is to drop the message.

According to the present invention there is still further provided a wireless communication system, comprising: a wireless communication infrastructure and client wireless communication devices (WCDs) communicating through the infrastructure; activity monitoring units being included within or being connected to at least some of the WCDs, each unit configured to intercept a message pushed to at least said WCD, to utilize at least one filtering rule concerning pushed messages to evaluate how to treat the intercepted message, and to drop the message if a result of said evaluating is to drop the message; and an activity monitoring server utility configured to communicate at least one filtering rule concerning pushed messages to each activity monitoring unit in accordance with a corresponding client profile at the server utility.

According to the present invention there is provided a program storage device readable by machine, tangibly embodying a program of instructions executable by the machine to perform method steps for monitoring activity of a wireless communication device (WCD) of a client comprising: intercepting a message pushed over a wireless communication infrastructure of a wireless communication system to at least the WCD of the client; evaluating how to treat the message utilizing at least one filtering rule relating to pushed messages; and if a result of the evaluating is to drop the message, dropping the message.

According to the present invention there is also provided a computer program product comprising a computer useable medium having computer readable program code embodied therein for monitoring activity of a wireless communication device (WCD) of a client, the computer program product comprising: computer readable program code for causing the computer to intercept a message pushed over a wireless communication infrastructure of a wireless communication system to at least the WCD of the client; computer readable program code for causing the computer to evaluate how to treat said message utilizing at least one filtering rule relating to pushed messages; and computer readable program code for causing the computer if a result of the evaluating is to drop the message, to drop the message.

### DETAILED DESCRIPTION OF THE INVENTION

The present invention is applicable to a wide variety of wireless communication systems. The invention is, however, particularly applicable for cellular communication systems, which are today the fastest growing communication infrastructures. At times the invention will be described with reference to the preferred embodiment of a cellular communication system, it being understood the invention is not limited thereto but applies more broadly to wireless communication systems in general, such as, for example, a one-way or two-way paging system.

The term “communication infrastructure” used below includes all the components of a communication system involved in the provision of communication service to the WCD. In the case of cellular telephone, these include the base stations of the various cells, a cellular telephone switching office that handles all the phone connections of cell phones which communicate with the base stations linked to the cellular telephone switching office, a central control system that coordinates activities of all central offices, etc.

The invention provides a novel solution to the problem of monitoring the communication activity of the client WCD. (Herein below the term client includes the subscriber of the service provider and/or the user of the WCD, as appropriate). In accordance with the invention, rather than continuously monitoring the communication activity of clients by utilizing central system resources, the activity is recorded by an activity-monitoring unit, which is installed in the client WCD. In a way, the WCD-associated activity-monitoring unit is an extension of the central activity-monitoring server utility of the system. In this way, the activity-monitoring solution provided by the invention requires considerably less system resources than existing, prior art activity-monitoring solutions, such as those described above. Through this unique solution, the invention, for one, allows to easily correlate between a certain client (or his WCD) and the communication activity performed by him, an extremely difficult endeavor in existing communication systems. The difficulties in monitoring the communication activity and correlating each with a specific client, is particularly an issue in existing cellular telephone systems as the client moves from one cell to another during a communication session. Furthermore, a system scale-up, in accordance with the invention, is easier than prior art communication activity-monitoring systems, as the scale-up, in accordance with the invention, requires a far less system upgrade and scale-up, as compared to prior art systems. This is particularly important for billing systems that are based on transmitted data packets or transmitted or received content, which is a highly complex endeavor in current systems.

The activity-monitoring solution in accordance with the invention, permits the monitoring and recording of the actual communication activity, including the actual communication service received by the client WCD, and thus permits to base billing on a variety of factors, not hitherto possible, that depend on such actual communication activity. For example, the invention permits to base billing on factors such as quality of service, e.g. the actual bandwidth allocated to a client at a particular time, avoid billing a client in the case of a disrupted communication session. Additionally, by remote setup of the activity-monitoring unit, individualized billing schemes are facilitated.

The WCD may be any wireless appliance, such as a client end unit of cellular communication network, e.g. a cellular telephone, a computerized device with a cellular modem, a cellular video phone, etc. In general, as will no doubt be appreciated by the artisan, the WCD may be any device having the ability to communicate over a wireless communication infrastructure, with a cellular communication infrastructure being a particular preferred embodiment, as already mentioned above.

The activity-monitoring unit may be installed within the WCD or may be connected thereto. For example, the WCD may be incorporated within the cellular modem.

The activity-monitoring unit may be used for monitoring different kinds of activities performed by the WCD. The activity-monitoring unit is a logical unit that can be either be a hardware device or a software utility with either dedicated hardware resources, dedicated software resources or both.

The activity recorded may be the extent of use of the WCD, the extent of communication traffic with the WCD, e.g. the number of data packets transmitted to the WCD. For example, in accordance with one embodiment, applicable in the case of a cellular telephone network, this data may be collected and thereafter the activity data transmitted to the monitoring server utility may then serve to bill the client for the “air time” utilized by the client with his WCD.

In accordance with another embodiment, the recorded activity may be usage of a computerized network accessed through the communication infrastructure (through a gateway provided by the service provider (SP)), the computerized network being typically, although not exclusively, the Internet. The computerized network may also be, for example, an intranet or an extranet. The activity recorded may be, for example: the time spent navigating through the network for charging the client based on such time; access by the client to sites of the network which require payment for access; the amount of bits (or bytes) or data packets transmitted to or from the WCD for a bill-by-bit (or bill-by-byte) or bill-by-data packets charging basis; the type of network-enabled service used by the WCD for charging the client on that basis; the bandwidth used for a specific activity, particularly where the bandwidth is controllable, for charging a client on the basis thereof; etc.

By another embodiment, the recorded activity may be transactions performed by the client, e.g. purchase of a product, service, data or content, within the computer network, through the use of his WCD. Transactions of this kind performed using a mobile communication unit are often referred to in the art as “mCommerce”. Such an activity record may then be used to bill the client for the transactions. The transactions-related activity record, transmitted to the activity-monitoring server utility creates a transaction activity record for which the client may be charged directly by the SP. The activity-monitoring server utility may thus serve in this case as a billing agent. The transaction charges may appear as a separate charge item in the periodical billing charges sent by the SP to the client. This is a new way of billing for transaction facilitated by the invention, which may replace the direct billing to a client account in a financial institution, e.g. to a credit card account, as in the prior art. However, the latter form of billing is also possible in accordance with the invention: the activity-monitoring server utility may also transmit the transaction or direct accounting (charging or crediting) data (the latter construed based on the activity data) to such a financial institution/client account.

In accordance with another embodiment, the recorded activity may be a certain transaction, which is billed to a third party. For example, occasionally a message is broadcasted to a plurality of cellular clients, for example, based on a specific client profile, and a third party is charged based on the number of clients that receive the broadcast. This may be the case, for example, where a service or product provider wishes to broadcast an advertisement relating to his provided services or products, respectively, with the charge being based on the number of actual cellular telephone users who received the advertisement. This is very difficult to do in current systems as the actual reception of a specific message depends on a variety of factors which cannot be effectively monitored centrally. For example, typically although not necessarily no acknowledgements are sent in response to a broadcast message, i.e. there is no direct handshake with receiving WCD(s) at any communication level.

The transmission of the activity data to the activity-monitoring server utility is performed automatically in a manner not controlled by a client. This ensures the integrity of activity data transfer to the server utility. Such transmission may be in a communication session initiated by said server utility, typically although not necessarily at time periods in which the wireless communication infrastructure is less busy, namely at off-peak periods. By another embodiment of the invention, the transmission may periodically be initiated by the activity-recording unit, e.g., automatically after passage of a predefined time or according to a predefined set of rules or alternatively when said unit senses an off-peak period. The exchange of data between said unit and said server utility may involve standard handshake protocols and will typically although not necessarily be in an encrypted form. The transmission protocols and method of encryption that are used may be such that are known per se and are thus readily available to a person versed in the art.

The term “activity-monitoring server utility” should be understood in the functional sense, namely as hardware/software combination that performs the functions as defined and explained herein. Said server utility may be comprised of one or more independent servers; or may be comprised within or integrated with the system of the SP; etc. Said server utility may be linked to an independent modem unit that communicates with all the activity-monitoring units within the WCDs through the communication infrastructure; or its communication interface may be integrated with the communication system infrastructure. As may readily be appreciated to the artisan, the invention is not restricted to any specific system architecture and any system having functions such as these defined and described above and bellow, is within the scope of the invention.

After transmission of information, the server utility may debit and transfer the money, for example, from a client to a merchant account, or in another case credit a client account. The client account may for example be a client account with the SP; or may be a credit or debit card account or another form of a client account in a financial institution, the details of which were a priori obtained for the specific client, in which case the server utility transits the transaction data to the financial institution for debiting or crediting the client's account there. The server utility obviously also has data on the other party of the transaction and initiates payment to or from such other party.

Performing transactions over a computer network is a specific embodiment of the invention. In accordance with this embodiment the unit of the WCD records particulars of the transaction and generates a transaction data record. This transaction data record is then utilized in order to debit or credit the client account, based on the type of transaction and, respectively, credit or debit the account of the party to the transaction which may be the provider of the service, product, data or other content. Generally, the transaction in accordance with this embodiment may be any type of mCommerce.

In accordance with one embodiment of the invention, the server utility can through communication with said WCD over the wireless communication infrastructure, set up or program said unit. For example, the unit may be set up to define a price structure or plan for a specific activity, a primary arrangement generally applicable or a specific one for the specific client, etc. The set-ups may include, for example, set-up for time-of-day—dependent billing, service-level agreement, quality of service set-up price structure, a content-based price structure, etc.

The activity monitoring unit typically although not necessarily comprises a data encryption module, for example an asymmetric data encryption standard accelerator for boosting performance of public key infrastructure (PKI) and secure a connection handshake and sign a document or certificate, or for example a symmetric data encryption standard for accelerating secure (encrypted) data transmission between the unit and the said server utility. Asymmetric data encryption standard accelerators include, for example, elliptic curve cryptography (ECC) accelerator, Rivest, Shanir and Adleman (RSA) accelerator, a Diffie-Helman (DH) accelerator, a multi-prime (MP) accelerator, and others. Symmetric data encryption standard accelerators are for example Data Encryption Standard (DES) accelerator, Advanced Encryption Standard (AES) accelerator that may be used in accordance with the invention and Secure Hash Algorithm 1 (SHA-1) accelerator.

The activity-monitoring unit may also comprise one or more real time clocks.

The WCD or said activity-monitoring unit may include safety features intended to block the ability to tamper with the device or with the automatic transmission feature, so as to ensure integrity of the activity data transmitted to said server utility.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows one example of a prior art activity monitoring system.

FIG. 2 shows another example of the prior art activity monitoring system.

FIG. 3 shows a system in accordance with an embodiment of the invention.

FIG. 4 is a schematic representation of a WCD in accordance with an embodiment of the invention.

FIG. 5A is a schematic representation of another embodiment of a WCD in accordance with the invention.

FIG. 5B is a schematic representation of a further embodiment of a WCD in accordance with the invention.

FIG. 6 is a schematic representation of an activity-monitoring unit in accordance with an embodiment of the invention.

FIG. 7 is a schematic representation of a software design operable in said unit, in accordance with an embodiment of the invention.

FIG. 8 shows another embodiment of the activity-monitoring unit.

FIG. 9 is a flowchart of a method for monitoring pushed data activity by the activity-monitoring unit, in accordance with an embodiment of the invention.

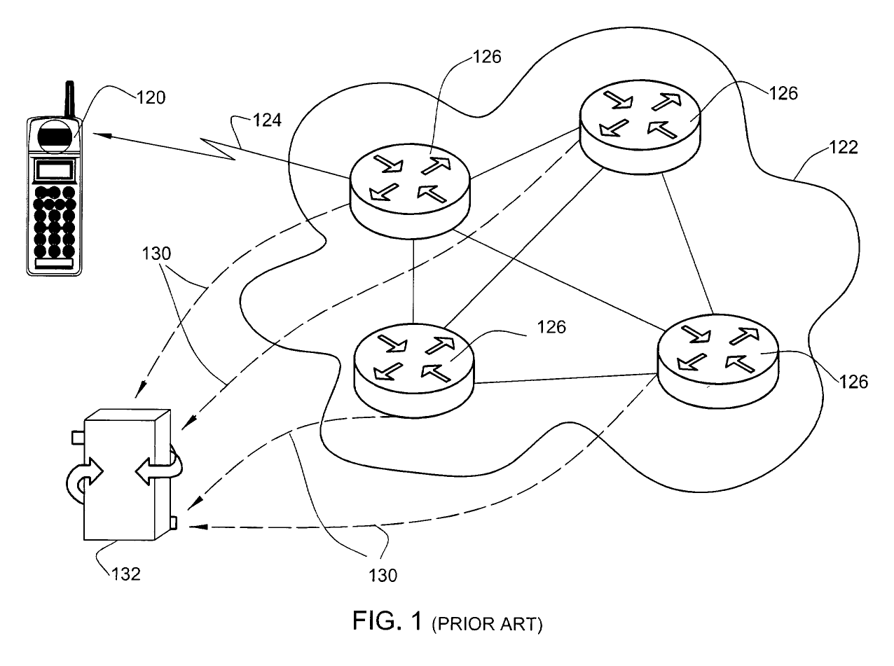

### DETAILED DESCRIPTION OF SPECIFIC EMBODIMENTS

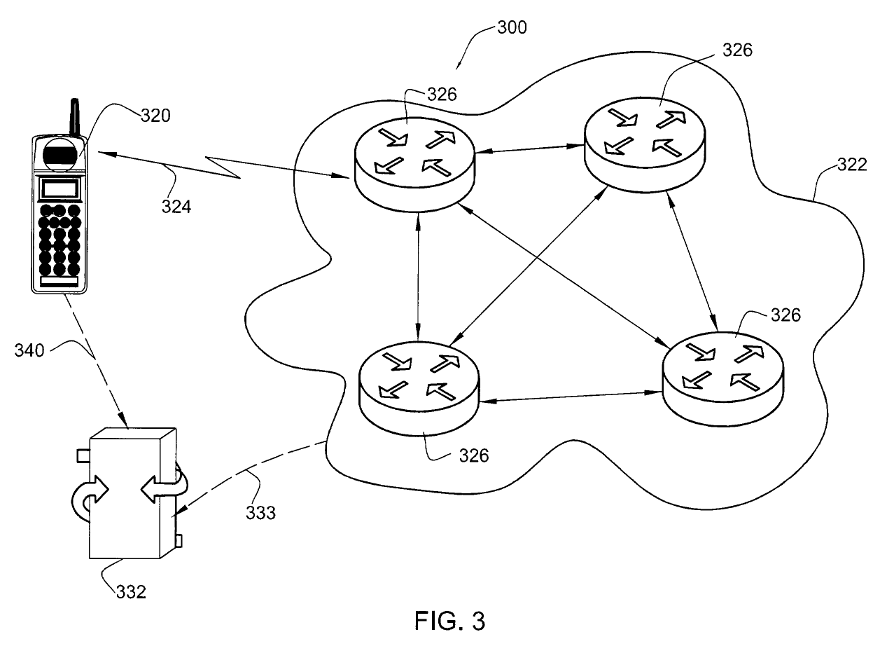

Reference is made to FIG. 3 showing a schematic representation of a design of a system generally designated 300 in accordance with an embodiment of the invention. In this embodiment, the communication infrastructure is a cellular network infrastructure, although it will be appreciated that this is an example and the invention is not limited thereto. The invention will be described in the following in reference to a cellular network as the wireless communication infrastructure, with an understanding that the description is applicable, mutatis mutandis to other wireless communication media.

The system 300 includes a cellular telephone infrastructure, represented, for the sake of simplicity, by means of bi-directional split arrow 324. A cellular network may be a standard cellular network, as known per se, supporting wireless communication of a plurality of users with wireless communication devices, such as cellular telephone device 320. It will be appreciated that the cellular telephone is an example only and the invention is applicable also to other type of communication devices equipped with a communication interface such as a modem, an Ethernet connection module, etc. permitting them to transmit and receive data, video or voice over a wireless network medium. The communication device 320 has incorporated therein an activity-monitoring unit (not shown in FIG. 3), which tracks activity by device 320. Such a monitoring operation may measure and record airtime usage, access to computer network, e.g. the Internet, entry of charging sites within computer network, transactions performed using the device 320, and others. In a preferred embodiment, the monitored activity constitutes transactions performed by device 320 within Internet 322 accessible through cellular communication network 324.

When accessing Internet 322, through a gateway provided by the cellular network 324, the device sends and receives data. The activity, in particular transactions performed within the Internet, for example purchase of a product or service, retrieving of information which requires payment, etc., is then recorded by the activity monitoring unit within device 320 and temporarily stored therein. The activity data is occasionally transmitted through the cellular network, represented by broken line 340, to an activity monitoring server utility 332, e.g. a charging gateway. The server utility 332 may be an independent unit communicating with devices 320 through the cellular network, although it is preferably a utility associated with or incorporated within the communication service operator. The transmitted activity data 340 may be a single record or may be multiple records, e.g. records relating to a plurality of transactions. Accumulating records over a period of time and sending of accumulated records only periodically, is a preferred embodiment of the invention.

The transmission of the activity data 340 may typically although not necessarily involve a handshake communication protocol and will preferably be encrypted. Furthermore, such transmission is automatic and in a manner not controllable by the client to assure integrity of transmitted activity data. It should be noted that server utility may itself be linked to the Internet, as represented by broken lines 333, for example, for the purpose of transmitting account data through the Internet to a financial institution holding a client account.

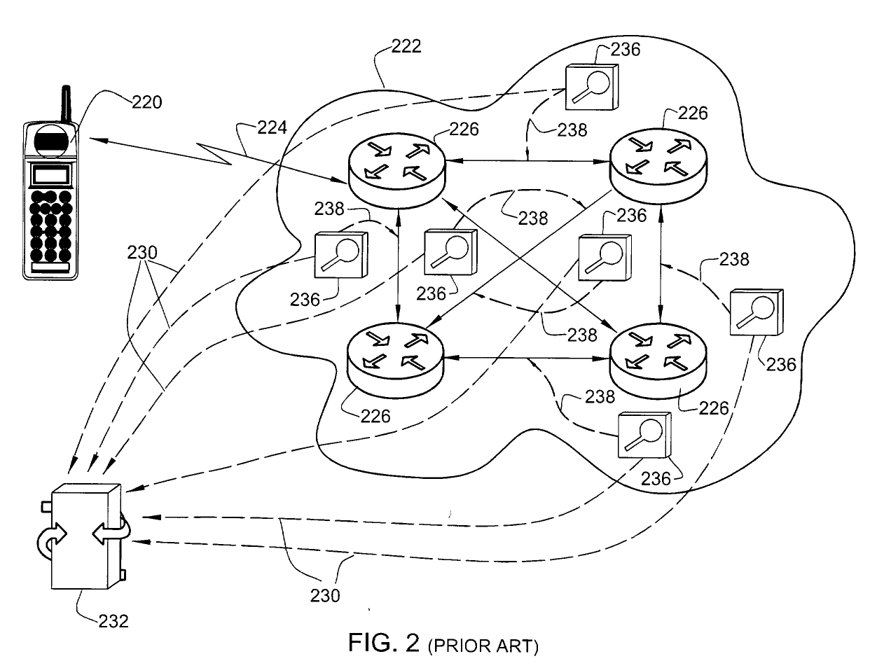

In accordance with the invention, DRs transmission from switches 326 or probes (see FIG. 2) is not required. This considerably reduces the load from switches 326 should the switches be probed as in accordance with the prior art.

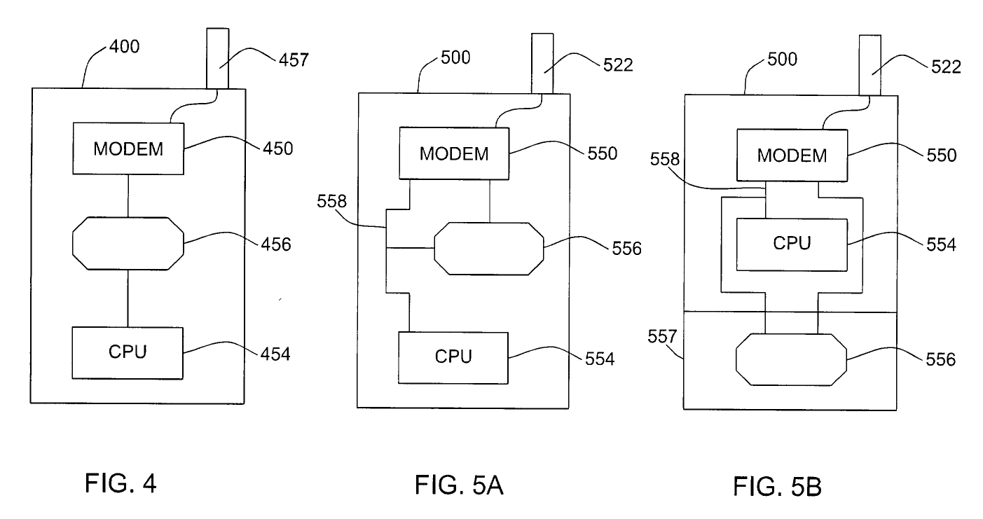

Reference is now being made to FIG. 4 showing a schematic representation of a wireless communication device in accordance with an embodiment of the invention. The illustrations of FIG. 4, as well as that of FIG. 5, are in fact logical representations. While the device is illustrated here as being comprised as several independent modules, in reality, while this may be the case, it is also possible to incorporate these independent modules into a single integrated circuit or unit. The text relating to FIGS. 4 and 5 should thus be read in this context.

Device 400 illustrated in FIG. 4, comprises, similar to prior art devices, a modem 450, linked to an antenna 452, and a central processing unit (CPU) 454. (Similarly as in the case of the prior art, device 400 comprises a user interface, e.g. a keyboard and display (not shown herein). In accordance with the invention communication device 400 comprises also an activity-monitoring unit 456 linking between CPU 454 and modem 450. In this manner, unit 456 monitors and records activity of device 400.

Another embodiment of a device 500 in accordance with the invention is shown in FIG. 5A. In this case, activity-monitoring unit 556 is linked to the Bus 558, linking CPU 554 to modem 550 and can thereby monitor and record the activity of device 500. Unit 556 is also linked to a modem 550 in a manner permitting it to occasionally transmit stored activity data, through the cellular communication infrastructure, to server utility 332 (see FIG. 3).

FIG. 5B shows a further embodiment in accordance with the invention. This embodiment is very similar to that shown in FIG. 5A and functionally like components were given like reference numerals to the corresponding components in FIG. 5A. The main difference in this embodiment is that the activity-monitoring unit 556 is included within the framework of an independent auxiliary device 557, which is connected to the WCD 500. Such an auxiliary device should, preferably, be built to be tampering-proof.

The transmission of activity data between units 456, 556 to the server utility may be pulled by the activity-monitoring server utility namely in a communication session initiated by said server utility, or alternatively, unit 456, 556 may be programmed to occasionally push the activity data, e.g. after a defined period of time, after a certain billable activity has been carried out, e.g. when the flash memory (see below) has been filled, etc.

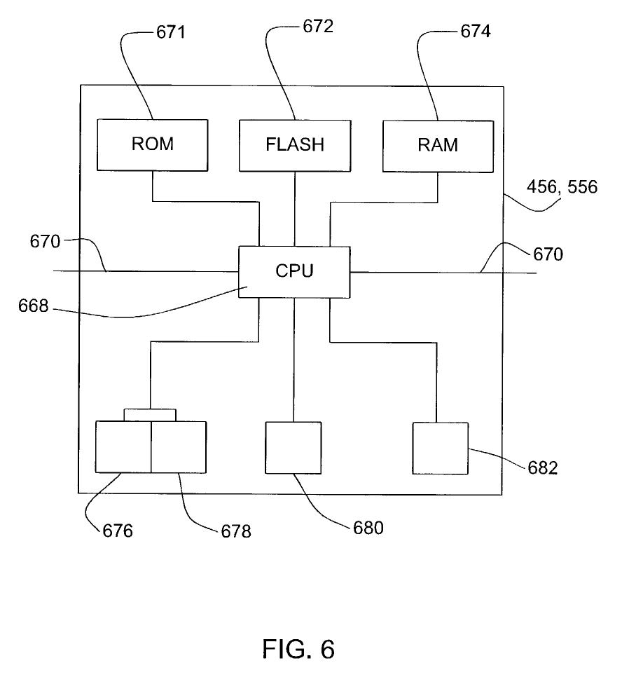

FIG. 6 shows a schematic representation of a hardware implementation of the activity-monitoring unit 456, 556. This unit comprises a (unit) CPU 668, linked through links 670 to the (main) CPU and the modem. The unit comprises three memories including a read only memory (ROM) 671, a flash memory 672 and a random Access memory (RAM) 674. The ROM is used to store the code section for the operation of CPU 668, is responsible for initial bootstrap procedure, and may also include a code for upgrade procedures and others. Flash memory 672 is dedicated to maintaining user configuration, e.g. configuration of the unit transmitted thereto from the operator. In addition, the flash memory records and stores the activity data that is to be transmitted at a later stage to the activity monitoring server utility. Furthermore the flash memory stores also part of the code of the device, mainly the part of the code that may be upgraded and updated.

The RAM is used, as known per se, to hold intermediate data needed for the operation of CPU 668.

Device 456, 556 may also comprise encryption modules such as for example an elliptic curve cryptography (ECC) accelerator 676 for boosting performance of the public key infrastructure and secure a connection handshake; as well as a data encryption standard (DES) accelerator 678 for boosting performance of the data transfer which is based on symmetric keys. Also included in device 456, 556 is a random key generator 680 that can produce a seed typically although not necessarily having a cycle of not less than 1,024 bits, as well as a timer 682, for example a 32-bit real-time clock.

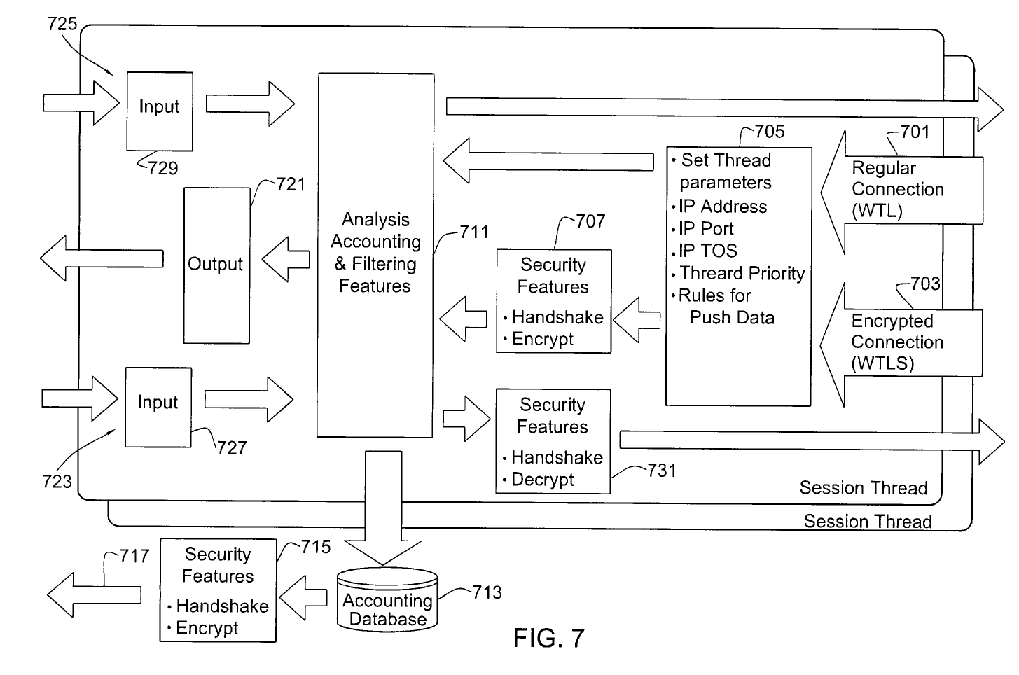

Reference is now being made to FIG. 7, illustrating the logical flow of data of multiple sessions through unit 456, 556. The data can flow from the CPU (not shown) of the wireless communication device either through a regular wireless transport layer (WTL) channel 701 or through a wireless transport layer security connection channel 703. The data then flows through a configuration database 705 setting the quality of service and addressing parameters. In case of an encrypted connection the data then flows through a security filter 707 that performs the handshake and hashing protocol required for a secure session. The data, either directly in the case of a regular connection, or via the security filter 707 in case of a secure connection, passes through accounting, analysis, and filtering logical block 711 that monitors the data and records activity data into an accounting database 713. The data is then transferred, through interface 721 to the modem of the device (not shown). The activity data, for example accounting data, is transmitted, typically although not necessarily through an output security filter 715, through the wireless communication infrastructure 717 to the activity-monitoring server utility.

Data in the reverse (incoming) direction is transferred through either a secure channel 723 or a regular channel 725 via interfaces 727, 729, respectively, through analysis, accounting, and filtering logical block 711 and then out, in case of a secure connection through input security filter 731 to the CPU (not shown). Activity data is recorded into accounting database 713 and transmitted, typically although not necessarily through output security filter 715, through the wireless communication infrastructure 717 to the activity-monitoring server utility.

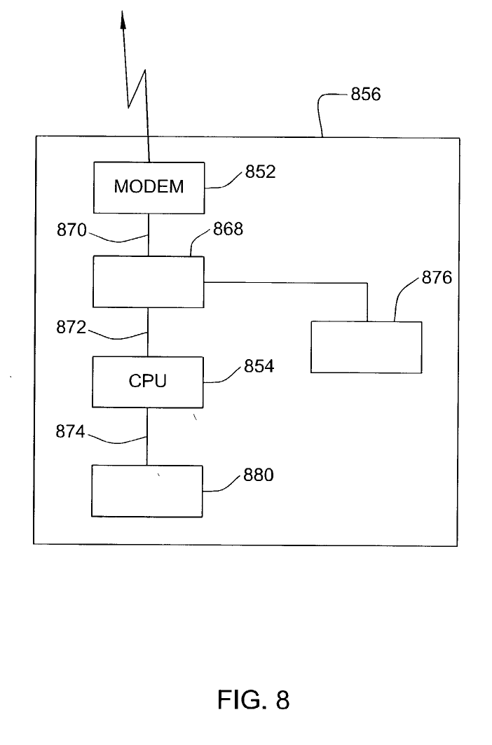

Reference is now being made to FIG. 8 showing another embodiment of the activity-monitoring unit. The activity-monitoring unit 856 comprises a software application (code) 868 linked through links 870 and 872 to a CPU 854 and modem 852, respectively. The unit comprises also a dedicated flash memory 876. Flash memory 876 maintains user configuration, for example, user configuration transmitted to the WCD from the operator. In addition, the flash memory records and stores the activity data that is to be transmitted at a later stage to the activity monitoring server utility of the SP. The flash memory may be a dedicated part of the WCD flash memory, may be a stand-alone flash memory or may be part of a Smart Card such as a SIM (subscriber identity module). Security features are implemented by the security unit 880 through its link 874 to the CPU 854.

The logical data flow of FIG. 7 can be adapted to activity monitoring unit 856 by making the appropriate changes. For example, logical blocks 713, 715, and 717 are inside unit 856, the traffic to/from the network (717, 721, 723, 725) is handled through modem 852, etc.

The usage of the activity-monitoring unit for pushed data will now be elaborated on. As it is well known in the art, pushed data is data that is sent to the WCD by a sender, for example by a content server and/or broadcast server, without a prior request for the data by the WCD. The pushed data may be sent in unicast mode, multicast mode or broadcast mode. It should be evident that broadcast mode is typically although not necessarily the most efficient mode, enabling the use of one radio channel for broadcasting to many WCDs, saving bandwidth and/or additional resources. For example, the sender can choose to broadcast within any broadcast range, for example from a single cell to the entire wireless communication system, and any range in between.

In the description below, it is assumed that the pushed data conforms to the SMS (short message service) standard. However, the pushed data can conform to any suitable standard for transmissions of cellular digital data on 2.5 G, 3 G or newer generation networks, including inter-alia short message service SMS, enhanced message service EMS, and multimedia message service, mutatis mutandis.

In a preferred embodiment of the present invention, the activity-monitoring unit intercepts all pushed messages. The activity monitoring unit may also account for the messages, reporting back periodically to the activity-monitoring server utility relevant statistics such as messages received, and/or accounting information for billing the client or a third party. In some cases, the activity-monitoring unit blocks messages from being forwarded (i.e. drops those messages). For example, the activity-monitoring unit may regulate the frequency of receptions of messages by the client. Continuing with the example, a client may be subscribed to receive three broadcast reports a day and any additional broadcast reports are dropped by the activity-monitoring unit.

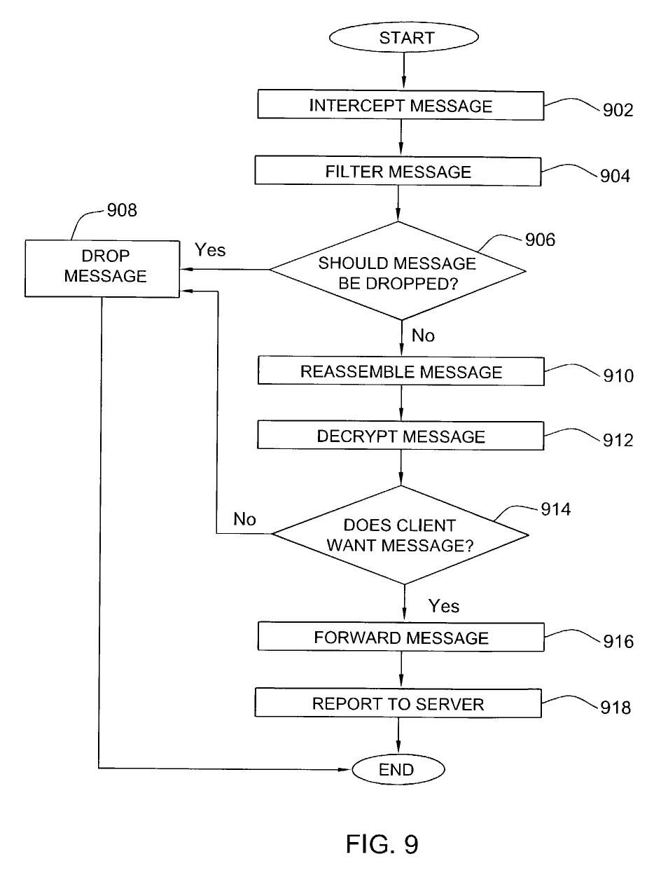

Refer to FIG. 9, which shows a flowchart of the method followed by the activity-monitoring unit for a received pushed message, according to a preferred embodiment of the present invention. Also refer back to FIG. 7 for an example of the logical flow of pushed data through the activity monitoring unit, according to a preferred embodiment of the present invention.

In step 902, the activity-monitoring unit intercepts the message. The message is received through either secure channel 723 or regular channel 725 via interfaces 727 or 729 respectively.

The message proceeds through analysis, accounting, and filtering logical block 711. Using filtering rules specific to the particular WCD in which the activity monitoring unit is placed, filtering logical block 711 filters the message, evaluating how to treat the message (step 904). As a result of the evaluation the message for example may be dropped (step 908) and the method ended, or the message for example may be retained and the method continued.

Filtering occurs in one embodiment when the unit recognizes the message as being a pushed message. For example, the message may be recognized as a pushed message by the address (for example broadcast messages in IP are typically although not necessarily sent to an IP address ending with all 1's). Alternatively, for example the WCD modem interface can indicate that the message was received on a broadcast channel. As another alternative example, the message may be recognized as pushed data based on a data tag (the tag may either be required as part of a particular standard or added to facilitate processing by the activity monitoring unit). The tag may for example be incorporated in an HTTP header.

In another embodiment, the filtering described herein occurs for all intercepted messages and no prior recognition of the message being a pushed message is required.

Preferably, the filtering rules are in accordance with the client profile at the activity monitoring server utility, as communicated by the activity monitoring server utility to the activity monitoring unit. (Note that typically although not necessarily, the activity monitoring server utility also communicates other configuration rules for example reporting rules and payment rules to the activity monitoring unit in addition to the filtering rules). The rules are stored in configuration database 705. Database 705 can be internal to the activity monitoring unit or external to the activity monitoring unit (for example in a smart card).

Typically, although not necessarily, the filtering rules relate to one or more parameters, solely or in combination. The values of these parameters for a particular message are preferably included in the data tag of the message. For example one parameter may be message type with possible message types (values) including advertisements or other third-party sponsored content, configuration message, subscription plan message, message containing free content, etc. Continuing with the example, another parameter may be message topic with possible topics (values) including: travel, stocks, sport, entertainment offers, etc.

For the sake of further illustration, assume the message type is a subscription plan message, where the subscriber pays per retained message. The message topic is stocks, and more particularly the Nokia stock (NOK). A sample data tag, for example, includes the following fields:

Product: Quotes ticker=NOK

Merchant: Quotes, Inc.

Price: 0.50

Currency: Euro

Quantity: 1

To give some examples of messages which in some embodiments may be dropped based on the filtering rules, consider the above described sample data tag. In one embodiment, unless the client profile states that the client subscribes to a stock subscription plan including Nokia, the message will be dropped.

As another example the filtering rules in accordance with a particular client profile may state that all advertisement messages should be dropped. Continuing with the example the client profile may specify that the user subscribes to advertisement free service. In another example, in certain embodiments if the media type of the message is not be supported by the WCD, the filtering rules may specify that such a message be dropped. In another example, in certain embodiments if the message is part of a periodic subscription service with a plurality of frequency based subscription plans, the filtering rules may specify that the message is retained or dropped depending on the relationship between the subscribed frequency (or subscribed time interval) and the actual number of messages received by the client in the last time period (or the time from client receipt of the previous message). Continuing with the example, assume that a particular client is subscribed to receive messages relating to a specific subscription service twice a day, the filtering rules may state that any pushed messages relating to the specific subscription service after the second pushed message per day is to be dropped. In another example, in certain embodiments if the message is part of a subscription service to which the client is not signed up, the filtering rules may specify that the message is dropped.

Optionally, the monitoring unit may forward to the WCD client interface a teaser mentioning that the message was dropped.

Assuming the message is retained, the method proceeds with optional step 910. It is assumed that in some cases longer messages may be split into smaller messages prior to being pushed by the sender to the WCD. In step 910, if necessary activity-monitoring unit reassembles fragments of a message into a full message. Preferably the re-assembly capability of the activity monitoring unit is more extensive than the standard provided support by the SMS standard, for example currently 15 pages of 82 (payload) bytes per message.

If the message is retained then after optional re-assembly, the message, if encrypted, is decrypted by input security filter 731 in optional step 912.

In optional step 914, the client is asked if the client wishes to receive the message. For example, the sender may push a song to many WCDs and each corresponding client can request to hear the song or have the song dropped. By pushing the song to the potential listeners, the sender saves the clients the waiting time between the request to hear the song and the playing of the requested song, compared to the case of the sender waiting for a song request before song transmission to the client.

If the message is dropped because the client does not want the message, the method ends. Otherwise the method continues with step 916.

In step 916, the message is forwarded to the CPU, in case of a secure connection through input security filter 731, and therefrom optionally to other components in the WCD. For example the message can be forwarded to the WCD client interface. As another example the message can be forwarded to a storage device, for example a smart card. As another example the message can be forwarded to another application on the WCD or locally connected device. For example, if the message is part of a subscription service, content may be forwarded to the appropriate application, for example a browser. As another example, if the message is intended to configure the WCD, the message may be forwarded to a terminal management application. As another example, if the message is an advertisement, the message may be forwarded to a message handling application.

In optional step 918, the activity-monitoring unit reports to the activity-monitoring server utility that the message was received and forwarded. In some cases, step 918 may be skipped, for example if the message represents free content and reporting is not desired for analysis purposes. Preferably the report for a particular message is not automatically sent immediately upon receipt of the message but the message is recorded in accounting database 713 and sent aggregated with other reports to the activity monitoring server utility, typically although not necessarily through output security filter 715, through the wireless communication infrastructure 717. The report can be used by the activity monitoring server utility for example, to bill the client, bill a third party, or for any data analysis application.

For example, if the message is an advertisement, the report may include the advertisement length, the advertisement source, and the advertisement price (if any). The activity monitoring server utility can then charge the vendor whose advertisement is the subject of the report, for example in accordance with an agreement with the vendor governing the provision of the advertisements.

In some embodiments, retained messages which were not forwarded (i.e. client did not want message) are nevertheless reported, for example because the messages used network resources. In other embodiment, retained messages which were not forwarded are not reported, for example because the message is an offer to sale which the client rejected.

In some embodiments, dropped messages are not reported to the activity monitoring server utility, In alternative embodiments, dropped messages are also reported to the activity monitoring server utility.

An example of an application for which the method of FIG. 9 can be applied includes counting the number of clients receiving an advertisement. In this application, the reports of step 918 from each WCD that receives an advertisement message are amalgamated to give the total number of clients who received the advertisement.

An example of another application is the receipt by an activity monitoring unit of the most popular, for example top ten, songs, icons, ring tones, etc. in step 902. The activity monitoring unit filters the received most popular items (step 904) and only retains the item and proceeds with the method (steps 910 to 918) if the client is subscribed to the service.

Another example of an application is news or weather updates, which are to be delivered at different frequencies (or different time intervals) according to different subscription plans. In step 904, the activity monitoring unit compares the frequency of the client subscription plan with the number of previous updates received and/or the time of last update and based on the comparison either drops the update (step 908) or proceeds with the method (steps 910 to 918).

Another example of an application is the delivery of pushed data relating to heavily traded stocks, which are of interest to a particular client to that client. In step 904, the activity monitoring unit compares the stock for which data was pushed with the list of stocks that are of particular interest to the client as indicated by the rules in accordance with the client profile and drops pushed data for stock which are not of interest (step 908) or proceeds with the method (steps 910 to 918).

Another example of an application is traffic report updates delivered according to location and subscription plans. For example, the traffic report update may be broadcast to all WCDs associated with a particular cell (corresponding to a specific location) but the activity monitoring unit of any client which is not subscribed to receive traffic updates will drop the update.

It should be noted that the usage of the activity monitoring unit as described in the above preferred embodiments eliminates the prior art requirement that the sender transmit deciphering key(s) to those (eligible) WCD(s) for which the data is destined in order that those WCD(s) can decipher the pushed data, and so that other WCD(s) which receive the pushed data but do not receive deciphering key(s) are forced to filter out (drop) the pushed data. Therefore, the usage of the activity monitoring unit as described in the above preferred embodiments lessens the management tasks of the sender because management of the deciphering keys is not required. In addition, if optional encryption/decryption is performed as described in the above preferred embodiments, it is easier for the sender to manage the encryption key(s) because in the above described preferred embodiments the management of the encryption key(s) is independent of which WCD(s) are eligible to receive the pushed data.

It will also be understood that the system according to the invention may be a suitably programmed computer. Likewise, the invention contemplates a computer program being readable by a,computer for executing the method of the invention. The invention further contemplates a machine-readable memory tangibly embodying a program of instructions executable by the machine for executing the method of the invention.

While the invention has been described with respect to a limited number of embodiments, it will be appreciated that many variations, modifications and other applications of the invention may be made.

1. A method for monitoring activity of a wireless communication device (WCD) of a client comprising:
installing in or connecting a WCD to an activity-monitoring unit configured to intercept a message pushed over a wireless communication infrastructure of a wireless communication system to at least said WCD;
upon interception of a pushed message, said activity-monitoring unit utilizing at least one filtering rule concerning pushed messages for evaluating how to treat said message; and
if a result of said evaluating is to drop said message, said activity monitoring unit dropping said message.

2. The method according to claim 1, further comprising: determining whether said message is a pushed message, wherein said utilizing is performed only if said message is first recognized to be a pushed message.

3. The method according to claim 1, wherein said message was broadcasted over said wireless communication infrastructure to all active WCDs in a predetermined area, said all active WCDs including at least said WCD.

4. The method according to claim 1, wherein said at least one filtering rule relates to at least one parameter of said message, wherein said at least one parameter is selected from a group including at least: message type and message topic.

5. The method according to claim 1, further comprising, if a result of said evaluating is to retain said message, retaining said message.

6. The method according to claim 5, wherein said retained message is forwarded.

7. The method according to claim 6, further comprising: obtaining approval of the client, wherein said retained message is forwarded only if client approval is first obtained.

8. The method according to claim 6, wherein said forwarding is to a WCD client interface.

9. The method according to claim 6, wherein said forwarding is to a storage device.

10. The method according to claim 6, wherein said forwarding is to another application.

11. The method according to claim 6, further comprising: generating a record of said forwarded message, aggregating said record with other records, and transmitting said aggregated records through said wireless communication infrastructure to an activity-monitoring server utility of said communication system.

12. The method according to claim 11, wherein said record enables said activity monitoring server utility to bill for said forwarded message.

13. The method according to claim 11, wherein said record enables said activity monitoring server utility to count the number of clients to which said message was pushed and forwarded.

14. The method according to claim 5, further comprising: reassembling fragments of said message.

15. The method according to claim 5, further comprising: decrypting said message.

16. The method of claim 1, wherein said at least one filtering rule was used to configure said activity monitoring unit.

17. The method according to claim 1, wherein said message is dropped because said message is associated with a subscription plan to which the client is not subscribed.

18. The method according to claim 1, wherein said message is dropped because said message is an advertisement and the client subscribes to an advertisement-free service.

19. The method according to claim 1, wherein said message is associated with a client subscription plan indicating a desired frequency of messages and said message is dropped because said frequency has already been reached.

20. The method according to claim 1, wherein said message is associated with a client subscription plan indicating a desired time interval between messages and said message is dropped because said time interval has not been reached.

21. A device for installing in or connecting to a client wireless communication device (WCD), the device comprising a unit that is configured to intercept a message pushed to at least said WCD, to utilize at least one filtering rule concerning pushed messages to evaluate how to treat said intercepted message, and to drop said message if a result of said evaluating is to drop said message.22. A client wireless communication device (WCD), permitting a client to communicate over a wireless communication infrastructure, said WCD having or being connected to an activity monitoring unit which is configured to intercept a message pushed to at least said WCD, to utilize at least one filtering rule concerning pushed messages to evaluate how to treat said intercepted message, and to drop said message if a result of said evaluating is to drop said message.

22.

23. A wireless communication system, comprising:
a wireless communication infrastructure and client wireless communication devices (WCDs) communicating through said infrastructure;
activity monitoring units being included within or being connected to at least some of said WCDs, each unit configured to intercept a message pushed to at least said WCD, to utilize at least one filtering rule concerning pushed messages to evaluate how to treat said intercepted message, and to drop said message if a result of said evaluating is to drop said message; and
an activity monitoring server utility configured to communicate at least one filtering rule concerning pushed messages to each said activity monitoring unit in accordance with a corresponding client profile at said server utility.

24. A program storage device readable by machine, tangibly embodying a program of instructions executable by the machine to perform method steps for monitoring activity of a wireless communication device (WCD) of a client comprising:
intercepting a message pushed over a wireless communication infrastructure of a wireless communication system to at least the WCD of the client;
evaluating how to treat said message utilizing at least one filtering rule relating to pushed messages; and
if a result of said evaluating is to drop said message, dropping said message.

25. A computer program product comprising a computer useable medium having computer readable program code embodied therein for monitoring activity of a wireless communication device (WCD) of a client, the computer program product comprising:
computer readable program code for causing the computer to intercept a message pushed over a wireless communication infrastructure of a wireless communication system to at least the WCD of the client;
computer readable program code for causing the computer to evaluate whether how to treat said message utilizing at least one filtering rule relating to pushed messages; and
computer readable program code for causing the computer if a result of said evaluating is to drop said message, to drop said message.
